(19) United States
(12) Patent Application Publication
(10) Pub. No.: US 2016/0005525 A1
(43) Pub. Date: Jan. 7, 2016

(54) INDUCTIVE COMPONENT

(71) Applicant: STS SPEZIAL-TRANSFORMATOREN-STOCKACH GMBH & CO. KG, Stockach (DE)

(72) Inventors: Christof GULDEN, Bodman-Ludwigshafen (DE); Bruce CARSTEN, Corvallis, OR (US); Stefan HERZOG, Radolfzell (DE); Alexander STADLER, Erlangen (DE)

(73) Assignee: STS Spezial-Transformatoren-Stockach GMBH & Co. KG, Stockach (DE)

(21) Appl. No.: 14/769,509

(22) PCT Filed: Dec. 9, 2013
(86) PCT No.: PCT/EP2013/075947

§ 371 Date: Aug. 21, 2015

(30) Foreign Application Priority Data
Mar. 11, 2013 (DE) 10 2013 204 171.3

(51) Int. Cl. H01F 27/25; H01F 1/057

(52) U.S. Cl. CPC H01F 27/25; H01F 1/057

(57) ABSTRACT

An inductive component with a magnetic circuit is made of a magnetically soft core material, the circuit having at least one gap which extends in the Y direction from a first end-side free end of the core material to an opposite second end-side end of the core material, at least one coil which is wound around at least one part of the core material, and a permanent magnet unit which consists of multiple mutually spaced individual permanent magnetic elements, each of which has a magnetizing direction, the directions oriented in an at least approximately identical manner to the Y direction The individual magnets are stacked next to one another in a mutually spaced manner in a direction which is at least approximately orthogonal to the Y direction. There is high magnetic biasing of the inductor by means of the permanent magnets, little power loss, a simple production, and a high fill factor.

### CROSS REFERENCE TO RELATED APPLICATIONS

This application relates to and claims priority as a 371 national-phase from PCT/EP2013/075947 filed Dec. 9, 2013, the entire contents of which are incorporated herein by reference, which claims priority from DE Ser. No. 10 2013 204 171.3 11 filed Mar. 11, 2013.

### FIGURE SELECTED FOR PUBLICATION

FIG. 1

### BACKGROUND OF THE INVENTION

1. Field of the Invention

The present invention relates to an inductive component. More particularly, the present invention provides an inductive component with a magnetic circuit made of a magnetically soft core material and a coil wound about a part of the core material are well known throughout the electrical engineering industry. The magnetic circuit frequently also has a gap that extends from a first free end on the front of the core material to a second free end on the front of the core material on the opposite side.

2. Description of the Related Art

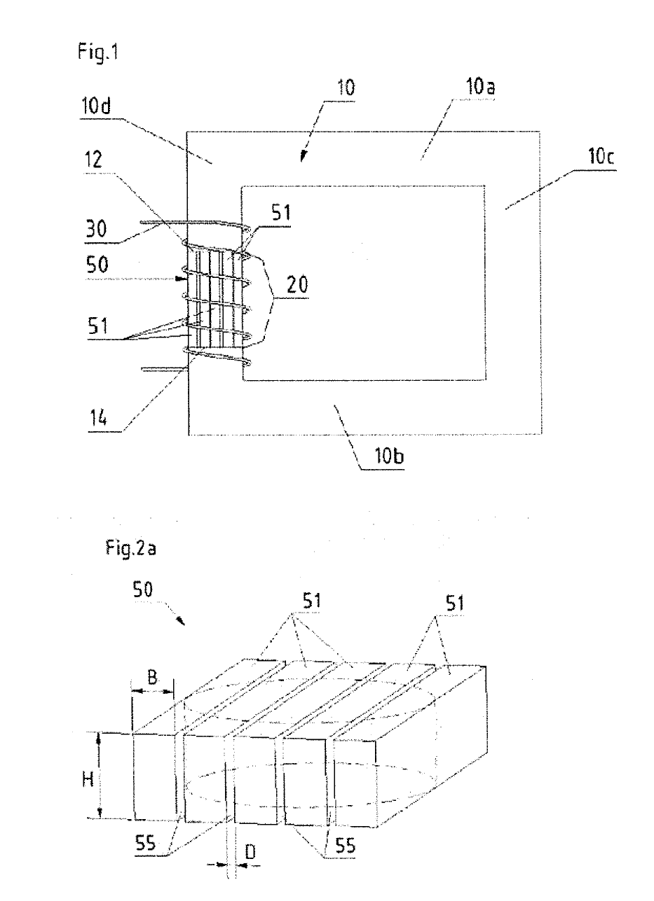

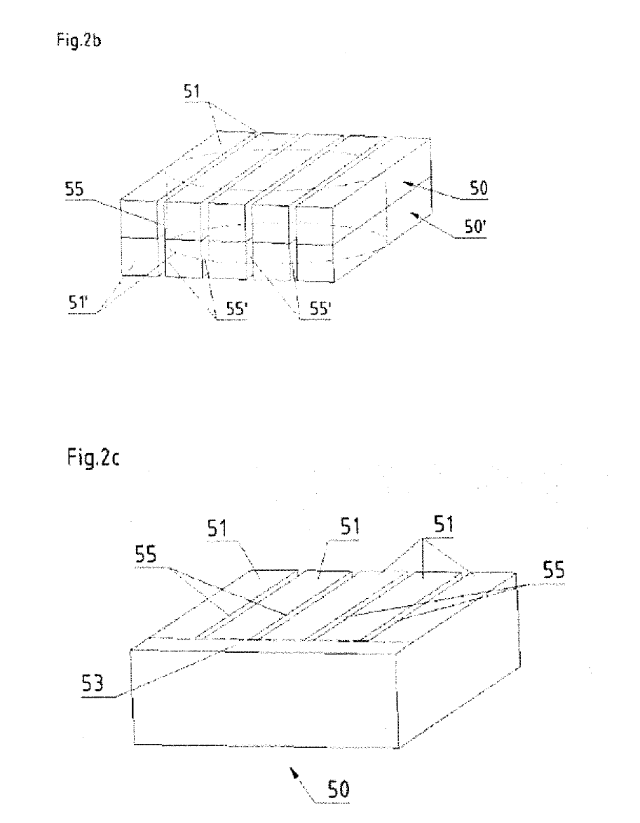

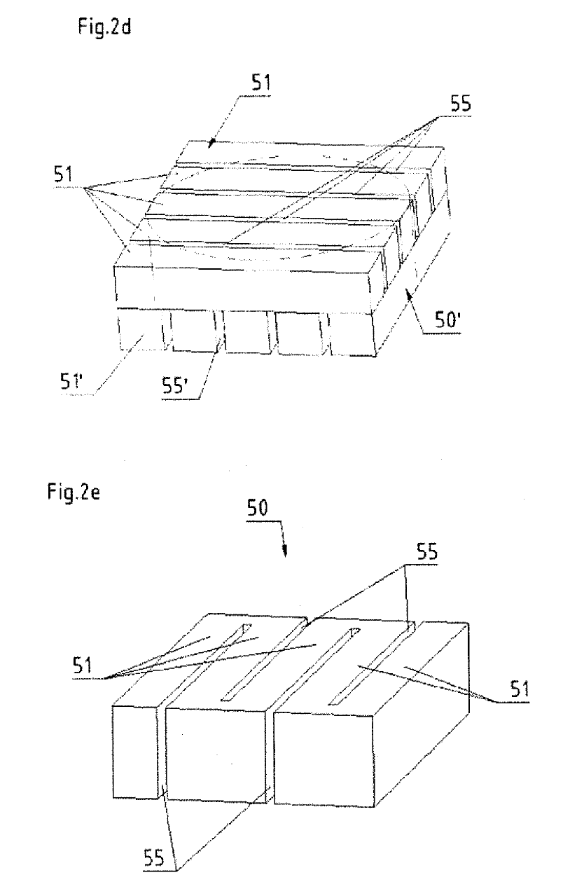

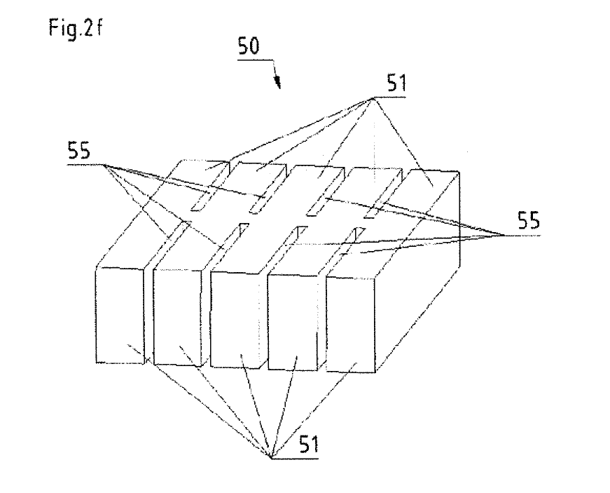

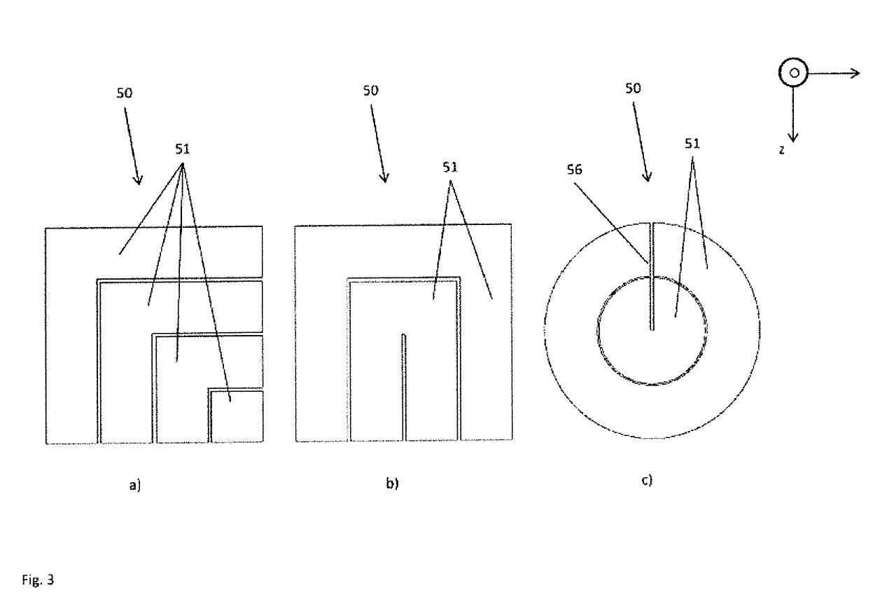

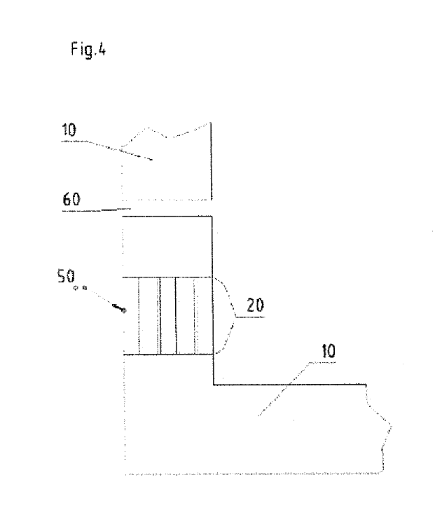

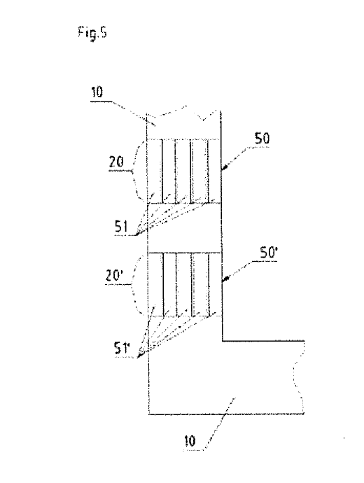

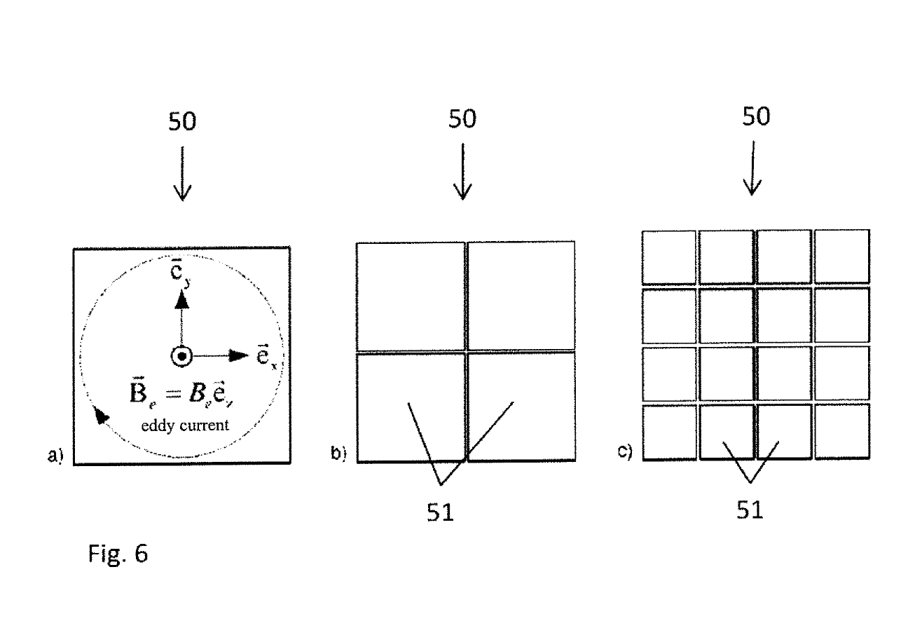

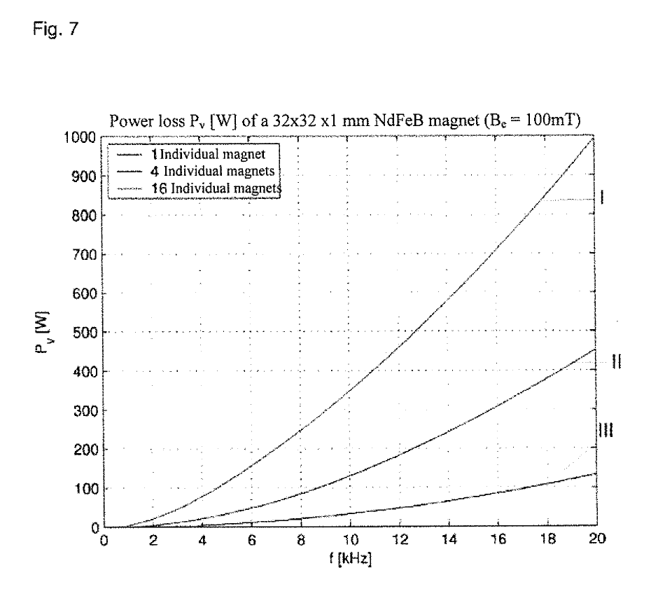

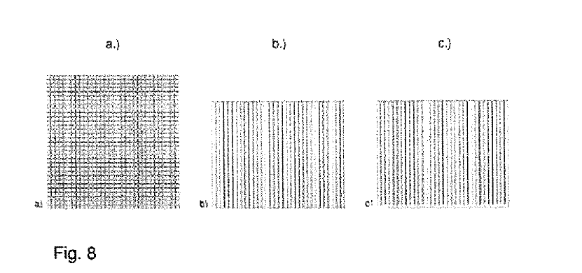

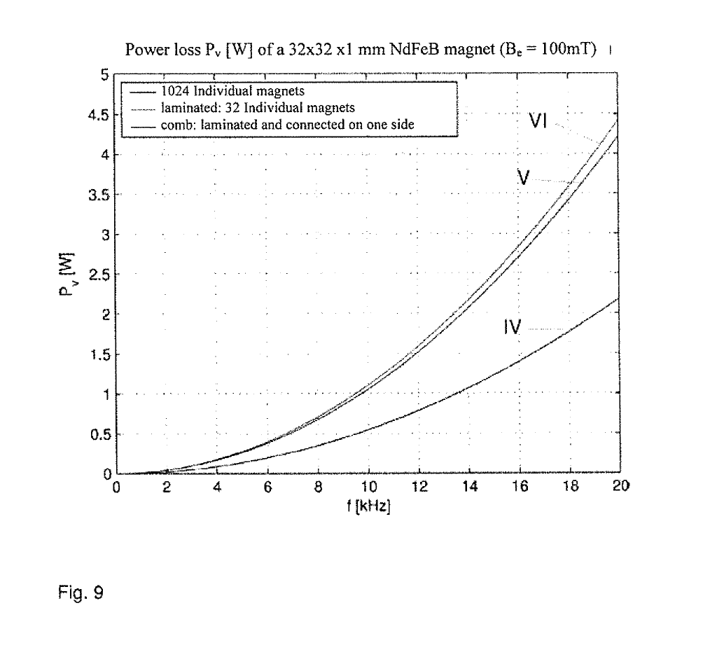

Such inductive components are used as voltage regulators in the form of so-called buck converters or step-up converters, for example. One example for a so-called step-up converter is disclosed in the introductory part of the specification of DE 198 16 485 A and the FIG. 1 therein.

This DE 198 16 485 A1 furthermore discloses biasing the inductive component magnetically negative, by filling the mentioned gap with permanent magnetic material, opposite to the field of winding. Because of this, it is possible to shift the actual operating range of the inductive component, because the maximum possible magnetic deviation, i.e. the maximum change, i.e. the maximum change in magnetic induction, is significantly increased by providing the permanent magnetic material in the gap.

If such permanent magnets are inserted in the gap of the magnetic circuit of the inductive component, however, undesirable eddy currents develop as soon as the inductive component conducts high-frequency a.c. components. The higher the frequency of the alternating magnetic field and the higher the energy of the alternating field, the larger the eddy currents will be.

This problem was identified in DE 2 424 131 A1, and it was proposed to subdivide the permanent magnet into a plurality of individual permanent magnet elements in order to reduce the eddy current losses. In a specific embodiment, a total of 25 individual permanent magnet elements were actually proposed, each of which are disposed as identical cubes in a 5×5 matrix within the gap (refer to FIG. 2 there).

The provision and in particular the alignment and the configuration of these individual permanent magnet elements in the gap creates problems, as is addressed in DE 2 424 131 A1 itself, because if these individual magnet elements are disposed in close proximity to each other, a repulsion between the magnet elements having the same polarity occurs when aligning the magnetizing directions of the individual permanent magnet elements. The individual magnetic pieces can therefore not be configured aligned, unless in this process sufficient spaces are maintained between adjacent individual permanent magnet elements. For that reason, it is proposed to glue the individual permanent magnet elements onto one of the end faces of the magnetic circuit facing the gap and then place the two-part magnetic circuit with the second front end onto the other side of the individual permanent magnet elements.

In addition, further assembly options are presented for the individual permanent magnet elements. Moreover it is proposed to glue the individual permanent magnet elements initially onto a film, for example, and then introduce these individual permanent magnet elements together with the film into the gap. Ultimately it is also discussed to install a multiplicity of recesses on the two opposite end faces of the free front ends of the magnetic circuit, into which the individual permanent magnet elements can be individually inserted in each case.

The assembly of these individual permanent magnet elements in the magnetic circuit and their fixation in situ is therefore problematic and more complex, even though the use of individual permanent magnet elements significantly reduces the eddy current losses of the inductive component.

Another problem when using a multiplicity of individual permanent magnet elements, in particular rectangular or cubic magnet elements, is the fact that the so-called fill factor becomes increasingly unfavorable, i.e. worse, because of the necessary spacing between the magnet elements. The fill factor stands for the ratio of the magnetically effective cross-section to the geometric cross-section.

The present invention is based on these findings.

Accordingly, there is a need for an improved inductive component that addresses at least one of the concerns noted above.

### ASPECTS AND SUMMARY OF THE INVENTION

According to one aspect of the invention there is provided an inductive component with a magnetic circuit is made of a magnetically soft core material, the magnetic circuit having at least one gap which extends in the Y direction from a first end-side free end of the core material to an opposite second end-side end of the core material, at least one coil which is wound around at least one part of the core material, and a permanent magnet unit which consists of multiple mutually spaced individual permanent magnetic elements, each of which has a magnetizing direction, the directions being oriented in an at least approximately identical manner to the Y direction The individual permanent magnets are stacked next to one another in a mutually spaced manner primarily in a direction which is at least approximately orthogonal to the Y direction. There is high magnetic biasing of the inductor by means of the permanent magnets, little power loss, a simple production, and a high fill factor.

One alternative aspect of the present invention is to develop the known inductance with inserted permanent magnets for magnetic biasing such that eddy current losses are kept low during operation on the one hand, and on the other that the manufacturing process will also be as uncomplicated as possible.

This aspect is solved by an inductive component with the features pursuant to the enclosure herein.

The inductive component according to the present invention is essentially based upon the fact that the individual permanent magnet elements are primarily stacked next to one another, and in a particular embodiment of the present invention are exclusively stacked next to one another in one direction, wherein the one direction is at least almost orthogonal to the Y-direction, i.e. in that direction which is given by the longitudinal extension of the gap in the magnetic circuit, which extends in the Y-direction from the first end-side free end of the core material to an opposite second end-side of the core material.

In a preferred embodiment of the present invention, it is provided that the individual permanent magnet elements are laminated, i.e. as lamellae or strips, the individual lamellae or strips being disposed reciprocally spaced apart in one direction.

Even though in principle it is possible that a thin air layer is provided as an insulator between the individual permanent magnet elements, there is also the option to use any other insulation material, for example a plastic film, a paper layer, an adhesive coating, or suchlike.

In another development of the present invention, it is provided that the height of the individual permanent magnet elements is larger in the Y-direction, i.e. in the longitudinal extension of the gap, than the width of the individual permanent magnet elements in stack direction. This width can be in the order of magnitude of 1 mm, for example.

It is also within the scope of the present invention that the inductive component has a further gap, in particular an air gap, which is provided in the magnetic circuit. This air gap can be provided as a separate gap next to the gap in which the permanent magnet unit is placed in the magnetic circuit. However, it is also possible that this further gap is a constituent of the one gap in which the permanent magnet unit rests. This means that the permanent magnet unit is spaced apart for example either from one or from both front faces of the core material consisting of magnetically soft material.

In one alternative embodiment of the present invention, the individual permanent magnet elements can be configured being stacked on top of one another in the gap direction.

There is the option of using a combination of rare earths as magnetic material of the individual permanent magnet pieces, for example SmCo, NdFeB, SmFeN or a hard ferrite, in particular SrFe, BaFe or a mixture of these materials. These first-mentioned magnetic materials are characterized by an exceptionally high residual flux density and a high magnetic coercitive field strength and thus by a high magnetic energy density.

Although the individual permanent magnet elements are formed as lamellae or strips situated side-by-side in a particular embodiment of the present invention, it is also within the scope of the present invention that the individual permanent magnet elements are reciprocally curved, in particular angled. It is moreover also possible that the individual permanent magnet elements are disposed reciprocally coaxial, or that the permanent magnetic unit is realized coaxially wound.

The permanent magnet unit can be particularly easily handled, if it is formed as comb structure, that is that the plurality of individual permanent magnet pieces are mechanically connected to one another as one piece or multi-piece in the form of lamellae or strips on one end or on one end face. Although as an option, the connection of the individual permanent magnet elements can also be provided at different positions within the permanent magnet unit, so that also a double comb structure with a connecting middle piece or a zigzag structure or still even other structures are possible for the permanent magnet unit.

The above and other aspects, features and advantages of the present invention will become apparent from the following description read in conjunction with the accompanying drawings, in which like reference numerals designate the same elements.

### BRIEF DESCRIPTION OF THE DRAWINGS

FIG. 1 shows the schematic structure of an embodiment of an inductive component according to the present invention.

FIGS. 2a-2f show six possible embodiments of a permanent magnet unit as it can be used in FIG. 1, as a perspective representation.

FIGS. 3a-3c are plan views of three further embodiments of permanent magnet units, as they can be inserted in FIG. 1.

FIG. 4 is a cutout of the magnetic circuit of an induction similar to FIG. 1 with a further gap.

FIG. 5 is a cutout of the magnetic circuit of an induction similar to FIG. 1 with two gaps, into each of which a permanent magnet unit with individual permanent magnet elements is inserted.

FIGS. 6a-6c are plan views of three different permanent magnet units, i.e. one with a single block, one with four individual permanent magnet elements and one with 16 individual permanent magnet elements.

FIGS. 7 shows the simulated power losses of the permanent magnet units of FIG. 6 depending on the frequency of an applied alternating field at constant alternating field amplitude.

FIG. 8 are plan views of three different permanent magnet units with 1024 individual permanent magnet elements, a laminated embodiment with permanent magnet strips and a comb structure of permanent magnet strips.

FIG. 9 illustrates the simulated power loss of the permanent magnet units illustrated in FIG. 8 depending on the frequency of the applied magnetic alternating field.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

Various operations may be described as multiple discrete operations in turn, in a manner that may be helpful in understanding embodiments of the present invention; however, the order of description should not be construed to imply that these operations are order dependent.

FIG. 1 shows a lateral view of the structure of an inductive component 1 with a magnetic circuit 10 consisting of magnetically soft core material, e.g. soft iron. The magnetic circuit 10 is formed annular with an upper cross limb 10a, with a spaced-apart lower cross limb 10b and two longitudinal limbs 10c and 10d interconnecting the two cross limbs 10a and 10b. The two cross limbs 10a, 10b and/or the two longitudinal limbs 10c and 10d can have a polygonal cross-section, but also a round or oval cross-section. In addition it also possible that the edges of the magnetic circuit 10 illustrated in FIG. 1 are rounded, wherein the magnetic circuit 10 can in particular also be shaped annular or toroidal. The longitudinal limb 10d shown on the left has a gap 20, which is bordered by a first end-side free end 12 of the core material of the magnetic circuit 10 and an opposite second end-side end 14 of the magnetic circuit 10. As the additionally illustrated coordinate diagram in FIG. 1 indicates, the gap 20 extends longitudinally from the first end side 12 to the second end side 14, which according to the present definition is the Y-direction Y. The two directions X and Z, which are also are positioned reciprocally perpendicular, are positioned orthogonal hereto.

A permanent magnet unit 50 rests in the gap 20, in order to cause a magnetic bias of the inductance 1. This permanent magnet unit 50 has a particular design and consists of a multiplicity of individual permanent magnet elements 51, which are primarily and preferably exclusively stacked spaced apart next to one another in one direction, wherein this one direction is at least approximately orthogonal, preferably exactly orthogonal to the mentioned Y-direction.

A coil 30 is wound about the longitudinal limb 10d illustrated on the left in FIG. 1. For this purpose, the coil 30 is wound about the permanent magnet unit 50.

FIG. 2a shows a perspective representation of the design and alignment of such a permanent magnet unit 50 with individual permanent magnet elements 51 stacked in X-direction, which in the present form are designed as individual permanent magnet strips or as individual permanent magnet lamellae. Each of these individual permanent magnet strips 51 has a width B in X-direction and a height H in Y-direction. The width B can be 0.1 to 5 mm, for example, preferably approximately 0.5 to 2 mm. For the height H, 0.1 to 10 mm can be provided, preferably approximately 0.5 to 5 mm, for example. An insulator 55 is located between the individual permanent magnet strips 51, which insulator can be formed from a plastic film, a paper layer or similar, for example.

Such a permanent magnet unit 50 in block form can be produced for example in that the individual permanent magnet strips 51 are bonded to each other or potted with the insulators 55. The entire permanent magnet unit 50 is inserted in the gap 20 of the entire magnetic circuit 10 in such a manner that the gap 20 is preferably completely filled by the permanent magnet unit 50. It is also possible, however, that one or both front sides 12, 14 are disposed spaced apart from the permanent magnet unit 50, so that a residual interspace to the permanent magnet unit 50 is formed. This residual interspace can also be filled with an insulator, e.g. plastic, for example.

But it was also found to be convenient to use a magnetic material for the permanent magnet unit 50 and therefore for the individual permanent magnet elements 51, which material consists of a combination of rare earths, in particular of SmCo, NdFeB, SmFeN or of hard ferrite, in particular SrFe, BaFe or a mixture of these materials. The first-mentioned materials are characterized by a high magnetic residual flux density and a high magnetic coercitive field strength, wherein the permanent magnets that are produced in this way have a high magnetic energy density.

FIG. 2b illustrates a similar permanent magnet unit 50 as that shown in FIG. 2a, in the form of individual permanent magnet strips 51 positioned side-by-side and which are reciprocally separated by insulation layers 55. To increase the magnetic energy density of the entire magnetic circuit 10, a second identically structured permanent magnet unit 50′ next to the permanent magnet unit 50 with individual permanent magnet strips 51′ and insulation layers 55′ is placed below the permanent magnet unit 50. Additional such permanent magnet units can be placed on top or underneath. In this context, the stacked permanent magnet units 50, 50′ can also be reciprocally rotated about the axis Y, as this is indicated in FIG. 2d.

FIG. 2d illustrates a 90° rotation of the upper permanent magnet unit 50 to the lower permanent magnet unit 50′. Other angles of rotation, such as 30°, 45° or 60° are also possible, The stacked permanent magnet units 50, 50′ moreover can also have a different height in Y-direction and/or have lamination of different thicknesses, for example.

Although previously only permanent magnet units 50, 50′ have always been described, which have a rectangular outer contour, it is easily possible to provide a cylindrical outer contour. In FIGS. 2a, 2b and 2d, this is indicated with a dashed line.

FIG. 2c illustrates a similar configuration of the permanent magnet unit 50 as illustrated in FIG. 2a. In contrast hereto, the individual permanent magnet strips 51 are connected to each other as one piece on their lower end of the area facing towards a viewer by means of a cross rib 53, so that a comb structure results for the permanent magnet unit 50. This comb structure has the advantage that the individual permanent magnet strips 51 are connected to each other mechanically, so that bonding the permanent magnet unit 50 together can be dispensed with. The insulation layers 55, as single slots, can be air-filled or be filled with an insulation material.

FIG. 2e illustrates a further rectangular body of a permanent magnet unit 50. Now, the insulation layers 55 are inserted into the permanent magnet unit 50 starting from the side facing towards a viewer and the opposite side of FIG. 2e in each case until shortly before the opposite end, so that an overall zigzag structure of the permanent magnet unit 50 results.

A so-called double comb structure of the permanent magnet unit 50 is illustrated in FIG. 2f. For this purpose, the individual permanent magnet elements 51 are connected to each other by a rib 54 in the middle.

FIG. 3 illustrates further embodiments of permanent magnet units 50 in plan view, also viewed in the Y-direction. FIG. 3a shows an L-shaped structure of the individual permanent magnet elements, FIG. 3b shows a U-shaped one, and FIG. 3c shows a coaxial structure of the permanent magnet unit 50.

Instead of the coaxial structure of the two individual permanent magnet elements 51 shown in FIG. 3c which is provided with a radial slot 56 to keep eddy current losses low, also a wound structure of the permanent magnet unit 50 can be provided.

The FIGS. 4 and 5 respectively show sections of a magnetic circuit 10 as it was presented in FIG. 1, wherein additional changes have still been done compared to the illustration of FIG. 1. According to FIG. 4, a further gap 60, here an air gap, is introduced into the magnetic circuit 10, to be able to specifically adjust the inductance and the saturation current intensity of the inductive component 1.

In FIG. 5, not only a gap 20 is provided for receiving the permanent magnet unit 50 with individual permanent magnet elements 51, but an additional gap 20′ is arranged in the magnetic circuit 10, in which an additional permanent magnet unit 50′ with individual permanent magnet elements 51′ is arranged, wherein these are reciprocally aligned in the same way as the individual permanent magnet elements 51 in the permanent magnet unit 50.

To clarify the mode of operation of a permanent magnet that has been inserted into a gap of a magnetic circuit according to the present invention, the FIGS. 6 to 9 will be examined in the following.

FIG. 6 again illustrates three different permanent magnet units 50 in plan view. FIG. 6a shows a permanent magnet unit 50 with one rectangular individual magnet, which has an edge length of 32 mm×32 mm, and is 1 mm thick, for example. The magnetic material of this individual magnet is sintered NdFeB.

FIG. 6b illustrates the same magnet as FIG. 6a, which is subdivided into four cubical rectangular individual magnet elements 51.

FIG. 6c still shows a further subdivided permanent magnet unit 50, i.e. such a one with the 16 individual permanent magnet elements, which are positioned reciprocally in a 4×4 matrix. In FIGS. 6b and 6c, the individual permanent magnet elements 51 are disposed at a minimum spacing from each other, so that it can be approximately assumed that the outer contour of these permanent magnet units 50 in FIGS. 6b and 6c will again be approximately 32 mm×32 mm. It is furthermore assumed that the permanent magnet unit 50 has a 1 mm thickness.

Assuming that the permanent magnet units 50 illustrated in FIGS. 6a, 6b and 6c are permeated by a time-varying magnetic field B, which, as indicated in FIG. 6a, projects from the plane of projection, then eddy currents are formed, this is likewise indicated by a circular arrow. These eddy currents flow clockwise, as indicated by the direction of the arrow in FIG. 6a.

If a magnetic field with an amplitude of Bₑ=100 mT is applied on the NdFeB magnet shown in FIG. 6a, this indicates a power loss as a function of the frequency of the applied alternating field, as it is shown in the upper curve I in FIG. 7. At a frequency of 20 kHz, this would ensue in an approximate 1000 W power loss, which naturally is unacceptably high.

If the magnet illustrated in FIG. 6a is subdivided into four individual permanent magnet elements according to FIG. 6b, this will produce the curve II of FIG. 7, which is significantly below the curve I. At a frequency of 20 kHz, however, it can be seen that there is still an unacceptable power loss of approximately 450 W.

For the permanent magnet unit 50 with sixteen individual permanent magnet elements 51 illustrated in FIG. 6c, the bottom curve III illustrated in FIG. 7 results. This curve III shows a further reduced power loss, but which is still somewhat above 100 W at a frequency of 20 kHz.

If the permanent magnet unit 50 is further subdivided into individual permanent magnet elements 51, as shown in FIG. 8a, specifically into one thousand and twenty-four individual permanent magnet elements, i.e. into a matrix of 32×32 individual permanent magnet elements 51, each of which are formed as cubes with an edge length of 1 mm, then the power loss at a frequency of 20 kHz can be reduced to approximately 2.2 W, as is shown by the curve IV in FIG. 9. If such a permanent magnet unit 50 with one thousand and twenty-four individual permanent magnet elements 51 is realized, however, this signifies considerable complexity during the production and also during the subsequent assembly into a gap 20 of an inductance 1 of such a permanent magnet unit 50.

It is significantly easier and almost just as effective, if the permanent magnet unit 50, as shown in FIG. 8b, is designed merely in thirty-two individual permanent magnet elements 51, in fact in the form of individual permanent magnet strips or individual permanent magnet lamellae. The characteristic curve associated with a permanent magnet unit according to FIG. 8b, is marked with V in FIG. 9. It is clearly apparent that at a frequency of approximately 20 kHz, only a slightly higher power loss compared to the curve of IV is to be noted. Here, the power loss at a frequency of 20 kHz is only approximately 4.2 W.

If the permanent magnet unit 50 of FIG. 8b is changed such that this is linked together on its bottom side pursuant to FIG. 8c, i.e. that it has a comb structure, then almost the same power loss curve (see the associated characteristic curve VI in FIG. 9) results as with the permanent magnet unit of FIG. 8b, i.e. the characteristic curve V there.

With the inductive component 1 according to the present invention, a particular advantage is also to be noted in the fact that a higher fill factor of the permanent magnet unit 50 is accomplished at an almost equally low power loss as with rectangular or cubic individual permanent magnet elements (see FIG. 8a). According to the prior art according to FIG. 8a, this will be 0.81, and 0.9 in the present invention (see FIG. 8b or 8a), which means an increase of 11%.

### LIST OF REFERENCE SYMBOLS

1 Inductive component
10 Magnetic circuit
10a Cross limb
10b Cross limb
10c Longitudinal limb
10d Longitudinal limb
12 First end-side free end
14 Second end-side free end
20 Gap
20′ Gap
30 Coil
50 Permanent magnet unit
50′ Permanent magnet unit
51 Individual permanent magnet elements, individual permanent magnet strips, individual permanent magnet lamella
51′ Individual permanent magnet elements, individual permanent magnet strips, individual permanent magnet lamella
53 Rib
54 Rib
55 Insulation layer
55′ Insulation layer
60 Further gap
X X-direction
Y Y-direction
Z Z-direction
H Height of the individual magnets 51 in Y-direction
B Width of the individual magnets 51
D Thickness of the insulation layer 55 in stack direction **

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

1. An inductive component comprising:
a magnetic circuit consisting of a magnetically soft core material;
the magnetic circuit, further comprising:
at least one gap which extends in a Y direction (Y) from a first end-side free end of the core material to an opposite second end-side free end of the core material;
at least one coil which is positioned wound around at least one part of the core material; and
a permanent magnet unit which consists of multiple mutually spaced individual permanent magnet elements, each of which has a magnetizing direction that is oriented in an at least approximately identical manner to the Y direction (Y), characterized by the following feature:
the individual permanent magnet elements are primarily stacked spaced apart next to one another in one direction, which is at least approximately orthogonal to the Y-direction (Y).

2. The inductive component, according to claim 1, wherein: the individual permanent magnet elements are stacked in the direction exclusively adjacently spaced apart.

3. The inductive component, according to claim 1, wherein: a height (H) of the individual permanent magnet elements is larger in the Y-direction than a width (B) of the individual permanent magnets in the stack direction.

4. The inductive component, according to claim 1, wherein: the individual permanent magnet elements are reciprocally disposed using respective insulation interlayers.

5. The inductive component, according to claim 4, wherein: the insulation layers have a thickness (D) in a stack direction that is smaller than the width (B) of the individual permanent magnet elements.

6. The inductive component. according to claim 1, wherein: at least one further gap in the magnetic circuit is filled with a magnetic insulator, in particular an air gap.

7. The inductive component, according to claim 1, wherein: the individual permanent magnet elements are disposed respectively stacked on top of each other also in Y-direction (Y).

8. The inductive component, according to claim 1, wherein: the magnetic material of the individual permanent magnet elements (51) consists of a combination of rare earths, selected from a group of rare earths consisting of at least one of SmCo, NdFeB, SmFeN or hard ferrite, SrFe, BaFe, and a mixture of these materials.

9. The inductive component, according to claim 1, wherein: at least a part of the individual permanent magnet elements is shaped as one of a curved shape and an angled shape.

10. The inductive component, according to claim 9, wherein: the individual permanent magnet elements are disposed reciprocally coaxial.

11. The inductive component, according to claim 1, wherein: at least two of the individual permanent magnet elements are connected magnetically to one another.

12. The inductive component, according to claim 1, wherein: the individual permanent magnet elements are connected to one another in a manner of one of a comb structure and a double comb structure.

13. An inductive component, comprising:
a magnetic circuit consisting of a magnetically soft core material;
the magnetic circuit, further comprising:
at least one gap which extends in a Y direction (Y) from a first end-side free end of the core material to an opposite second end-side free end of the core material;
at least one coil which is positioned wound around at least one part of the core material; and
a permanent magnet unit which consists of multiple mutually spaced individual permanent magnet elements, each of which has a magnetizing direction that is oriented in an at least approximately identical manner to the Y direction (Y), characterized by the following feature:
the individual permanent magnet elements are primarily stacked spaced apart next to one another in one direction, which is at least approximately orthogonal to the Y-direction (Y);
the individual permanent magnet elements are stacked in the direction exclusively adjacently spaced apart;
a height (H) of the individual permanent magnet elements is larger in the Y-direction than a width (B) of the individual permanent magnets in the stack direction;
the individual permanent magnet elements are reciprocally disposed using respective insulation interlayers; and
the insulation layers have a thickness (D) in a stack direction that is smaller than the width (B) of the individual permanent magnet elements.

14. The inductive component, according to claim 13, wherein: at least a part of the individual permanent magnet elements is shaped as one of a curved shape and an,-angled shape.

15. The inductive component, according to claim 14, wherein: the individual permanent magnet elements are disposed reciprocally coaxial.

16. The inductive component, according to claim 15, wherein: at least two of the individual permanent magnet elements are connected magnetically to one another.

17. The inductive component, according to claim 16, wherein: the individual permanent magnet elements are connected to one another in a manner of one of a comb structure and a double comb structure.

18. An inductive component, comprising:
a magnetic circuit consisting of a magnetically soft core material;
the magnetic circuit, further comprising:
at least one gap which extends in a Y direction (Y) from a first end-side free end of the core material to an opposite second end-side free end of the core material;
at least one coil which is positioned wound around at least one part of the core material; and
a permanent magnet unit which consists of multiple mutually spaced individual permanent magnet elements, each of which has a magnetizing direction that is oriented in an at least approximately identical manner to the Y direction (Y), characterized by the following feature:
the individual permanent magnet elements are primarily stacked spaced apart next to one another in one direction, which is at least approximately orthogonal to the Y-direction (Y);
the individual permanent magnet elements are stacked in the direction exclusively adjacently spaced apart;
the individual permanent magnet elements are reciprocally disposed using respective insulation interlayers;
the insulation layers have a thickness (D) in a stack direction that is smaller than the width (B) of the individual permanent magnet elements; and
at least a part of the individual permanent magnet elements is shaped as one of a curved shape and an angled shape.

19. The inductive component, according to claim 18, wherein: the individual permanent magnet elements are disposed reciprocally coaxial.

20. The inductive component, according to claim 19, wherein: at least two of the individual permanent magnet elements are connected magnetically to one another.
